(19) United States
(12) Patent Application Publication
(10) Pub. No.: US 2010/0253579 A1
(43) Pub. Date: Oct. 7, 2010

(54) Antenna with 3-D Configuration

(76) Inventors: Byung Hoon Ryou, Seoul (KR); Won Mo Sung, Gyeonggi-do (KR); Gi Seck Seoung, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/308,652

(22) PCT Filed: Jun. 27, 2007
(86) PCT No.: PCT/KR2007/003106

§ 371 Date: Jun. 15, 2010

(30) Foreign Application Priority Data
Jun. 30, 2006 (KR) 10-2006-0060320

(51) Int. Cl. H01Q 1/38

(52) U.S. Cl. 343/700 MS

(57) ABSTRACT

Disclosed herein is an antenna comprising: a first dielectric element having a first slit formed thereon; a first radiator formed on the first dielectric element; a second dielectric element coupled to the first dielectric element in such a fashion as to be fit into the first slit of the first dielectric element; and a second radiator formed on the second dielectric element and coupled electrically with the first radiator through the coupling between the first dielectric element and the second dielectric element. The present invention provides an antenna which can maximize an electrical length thereof in a limited space, can be designed even in a three-dimensional space, and can be fabricated simply at low cost.

### TECHNICAL FIELD

The present invention relates to an antenna for a wireless communication terminal, and more particularly, to an antenna with a three-dimensional configuration which can maximize an electrical length thereof in a limited space and can extend a degree of freedom of design up to a three-dimensional space.

### BACKGROUND ART

Along with a trend toward compactness of a wireless communication terminal, a space for an antenna to occupied becomes gradually small whereas the demand for performance of the antenna is increasingly becoming higher. A three-dimensional shaped radiator is taken from an example of researches being conducted in order for an antenna occupying a limited space to have multi-band and broadband resonance properties or have an electrical length suitable for resonating for a low frequency band signal such as a VHF band signal used in a terrestrial digital multimedia broadcasting (T-DMB). The reason for this is that an antenna having the three-dimensional shaped radiator has a merit in that a remarkably higher degree of freedom in terms of a shape design for implementing an intended radiation characteristics as compared to a flat antenna, as well as can extend an electrical length thereof through the efficient use of a narrow space.

A method of bending a conductive radiator using a press is well known as a method for implementing the three-dimensional shaped radiator. However, the conventional method has a demerit in that it is difficult to implement a complex shaped structure into a compact one.

Korean Patent No. 374667 discloses a method in which a heavy metal-containing component is coated on a non-conductive support material, and an electromagnetic radiation in a UV-region is selectively applied to a region of a conducting path structure to be created so as to emit a heavy metal core and metallize the region by a chemical reduction. By the above method, a three-dimensional and complex shaped radiator can be implemented on the non-conductive support material. But, this method entails a shortcoming in that it is complicated in the manufacturing process and is ex-cessively high-priced as compared to a compact antenna.

### DISCLOSURE OF INVENTION

### Technical Problem

Accordingly, the present invention has been made in an effort to solve the above-mentioned problems occurring in the prior art, and it is an object of the present invention to provide an antenna which can maximize an electrical length thereof in a limited space and can be designed even in a three-dimensional space.

Another object of the present invention is to provide an antenna with a three-dimensional configuration which enables formation of patterns by conductive ink printing and can be fabricated simply at low cost.

### Technical Solution

To accomplish the above object, according to one aspect of the present invention, there is provided an antenna comprising: a first dielectric element having a first slit formed thereon; a first radiator formed on the first dielectric element; a second dielectric element coupled to the first dielectric element in such a fashion as to be fit into the first slit of the first dielectric element; and a second radiator formed on the second dielectric element and coupled electrically with the first radiator through the coupling between the first dielectric element and the second dielectric element.

Preferably, the second dielectric element may have a second slit formed thereon in such a fashion as to be opened at one end thereof, and the first dielectric element may be fit into the second slit of the second dielectric element upon the coupling between the first dielectric element and the second dielectric element.

Preferably, the first slit may be opened at one end thereof.

Also, preferably, each of the first radiator and the second radiator may be formed by printing a conductive ink on the first dielectric element and the second dielectric element, respectively.

According to another aspect of the present invention, there is provided a wireless terminal device comprising the antenna.

### Advantageous Effects

According to the antenna of the present invention, it is possible to maximize an electrical length of the antenna in a limited space and design the antenna in a three-dimensional space.

Also, according to the present invention, it is possible to provide an antenna with a three-dimensional configuration which enables formation of patterns by conductive ink printing and can be fabricated simply at low cost.

### BRIEF DESCRIPTION OF THE DRAWINGS

FIG. 1 is a perspective view illustrating an antenna according to one embodiment of the present invention;

FIG. 2 is a perspective view illustrating the structure of dielectric elements having different shaped slits from those of FIG. 1;

FIG. 3 is a perspective view illustrating the structure of dielectric elements different shapes from those of FIG. 1; and

FIG. 4 is a perspective view illustrating the structure of three dielectric elements having radiators formed thereon.

### BEST MODE FOR CARRYING OUT THE INVENTION

Reference will now be made in detail to a preferred embodiment of the present invention with reference to the attached drawings.

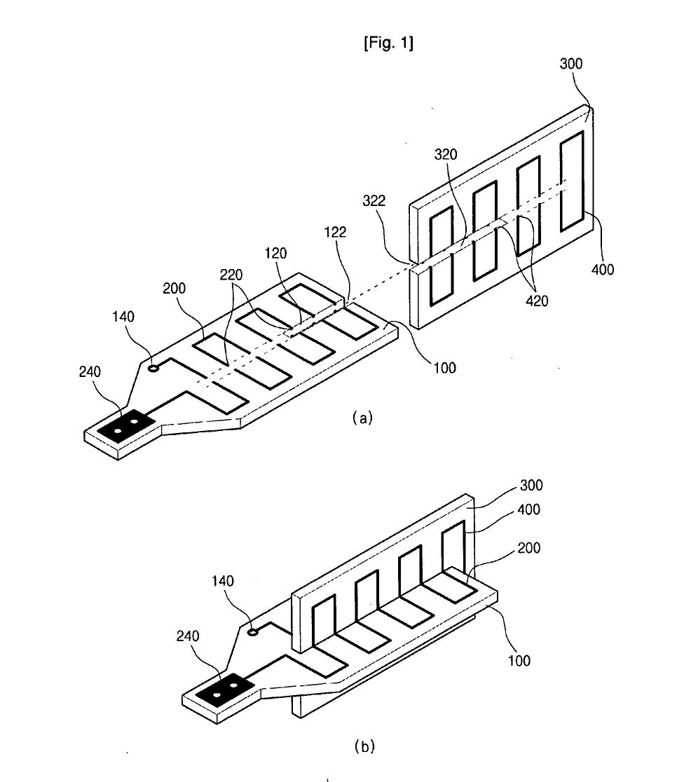

FIG. 1 is a perspective view illustrating an antenna according to one embodiment of the present invention.

Referring to FIG. 1, an antenna according to this embodiment comprises: a first dielectric element 100 having a first slit 120 formed thereon; a first radiator 200 formed on the first dielectric element 100; a second dielectric element 300 coupled to the first dielectric element 100 in such a fashion as to be fit into the first slit 120 of the first dielectric element 100; and a second radiator 400 formed on the second dielectric element 300. FIG. 1(a) shows a state prior to the second dielectric element 300 is coupled to the first dielectric element 100, and FIG. 1(b) shows a state after the second dielectric element 300 is coupled to the first dielectric element 100.

The first and second dielectric elements 100 and 300 can be implemented with a printed circuit board (PCB), and the first and second radiators 200 and 400 can be formed by printing a conductive ink along a predetermined pattern on the first and second dielectric elements 100 and 300 implemented with the printed circuit board (PCB). By doing so, a complex radiator pattern can be more easily and freely formed. The radiators 200 and 400 may be formed on the front surface and the rear surface of each of the dielectric elements 100 and 300. At this time, the electrical connection between a pattern formed on the front surface of the dielectric element and a pattern formed on the rear surface of the dielectric element can be achieved through a via hole 140 which can be formed on the dielectric elements 100 and 300 implemented with the printed circuit board (PCB). Referring to FIG. 1(b), the radiators 200 and 400 can be formed at one end thereof with a power feed portion 240 for the feed of power.

The first slit 120 formed on the first dielectric element 100, as shown in FIG. 1, may be opened at its one end 122 and the second dielectric element 300 can be fit into the first slit 120 of the first dielectric element 100 through the one end 122 of the first slit 120. The first slit 120 may have various shapes correspondingly so as to allow the second dielectric elements of various shapes to be fit thereto.

The second dielectric element 300 is also formed with a second slit 320 opened at its one end 322, so that when the second dielectric element 300 is fit into the first slit 120 so as to be coupled to the first dielectric element 100, the first dielectric element 100 can also be fit into the second slit 320 of the second dielectric element 300 through the open one end 322 of the second slit 320. By doing so, the first dielectric element 100 and the second dielectric element 300 are securely coupled to each other.

The first radiator 200 formed on the first dielectric element 100 and the second radiator 400 formed on the second dielectric element 300 can be electrically connected with each other through the coupling between the first dielectric element 100 and the second dielectric element 300. Thus, as shown in FIG. 1(b), the radiators 200 and 400 can be formed in a three-dimensional shape as designed. Particularly, in case where the radiators 200 and 400 are all formed on both surfaces of the first dielectric element 100 and the second dielectric element 300, respectively, it is possible secure an electrical length extending two times that of a general PCB antenna in which a radiator is formed on only one surface of a dielectric element. In order to ensure that such electrical connection between the first radiator 200 and the second radiator 400 is achieved, the first radiator 200 or the second radiator 400 can have an extension portion 220 at each contact point thereof. Alternately, the first radiator 200 and the second radiator 400 are not in direct contact with each other, but may be electromagnetically coupled with each other upon the coupling between the first dielectric element 100 and the second dielectric element 300. The term used herein, ‘electrical coupling’ comprises both electrical connection and electromagnetic coupling.

In this embodiment, by a simple configuration of the slits 120 and 320 formed on the dielectric elements 100 and 300, respectively, two dielectric elements 100 and 300 are coupled to each other to thereby implement a three-dimensional shaped radiator. Accordingly, it is possible to maximize an electrical length of the radiator in a limited space, and easily extend a degree of freedom of design from a two-dimensional space to a three-dimensional space to thereby facilitate the implementation of desired characteristics. Furthermore, since a flat dielectric element such as a PCB can be used, a complex pattern can be formed by a conductive ink printing method and the coupling between the two dielectric elements is achieved by the engagement between the two slits of the dielectric elements, thereby reducing the manufacturing cost and making the manufacturing process simple to improve productivity.

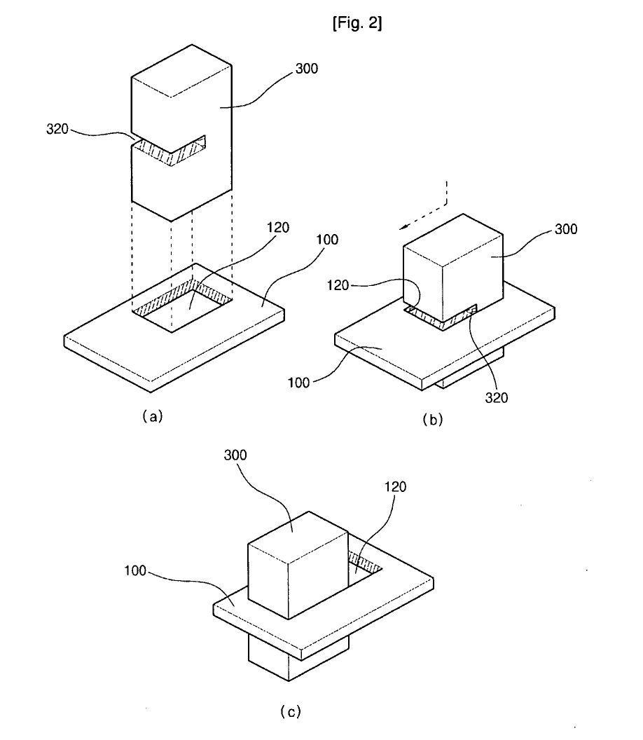

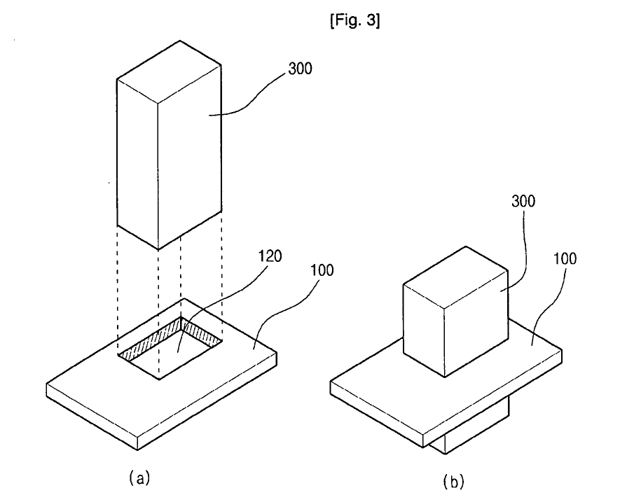

In the meantime, the first slit formed on the first dielectric element may be formed such that its one end is not opened, the second dielectric element may not be formed with the second slit opened at one end thereof. FIGS. 2 and 3 are perspective views illustrating the structure of dielectric elements having different shaped slits according to various embodiments of the present invention. In FIGS. 2 and 3, radiators formed on the dielectric elements 100 and 300 are not shown.

FIG. 2(a) shows a state prior to the coupling between the first dielectric element 100 and the second dielectric element 300, FIG. 2(b) shows a state in which the second dielectric element 300 is inserted into a first slit 120 formed in the first dielectric element 100, and FIG. 2(c) shows a state in which the second dielectric element 300 is inserted into the first slit 120, and then the first dielectric element 100 is fit into the second slit 320 formed in the second dielectric element 300 to thereby achieve the coupling between the fust dielectric element 100 and the second dielectric element 300. As shown in FIG. 2, the first slit 120 formed in the first dielectric element 100 may not be opened at one end thereof. The radiators can be formed on the dielectric elements 100 and 300 so as to implement a three-dimensional shape through the coupling between the first dielectric element 100 and the second dielectric element 300. The radiators may be formed on the surface or at the inside of each of the dielectric elements 100 and 300.

FIG. 3(a) shows a state prior to the coupling between the first dielectric element 100 and the second dielectric element 300, FIG. 3(b) shows a state after the coupling between the first dielectric element 100 and the second dielectric element 300. As shown in FIG. 2, the second dielectric element 300 may not be formed with the second slit opened at one end thereof. The second dielectric element 300 is inserted into a first slit 120 formed in the first dielectric element 100 so as to be coupled with the first dielectric element 100.

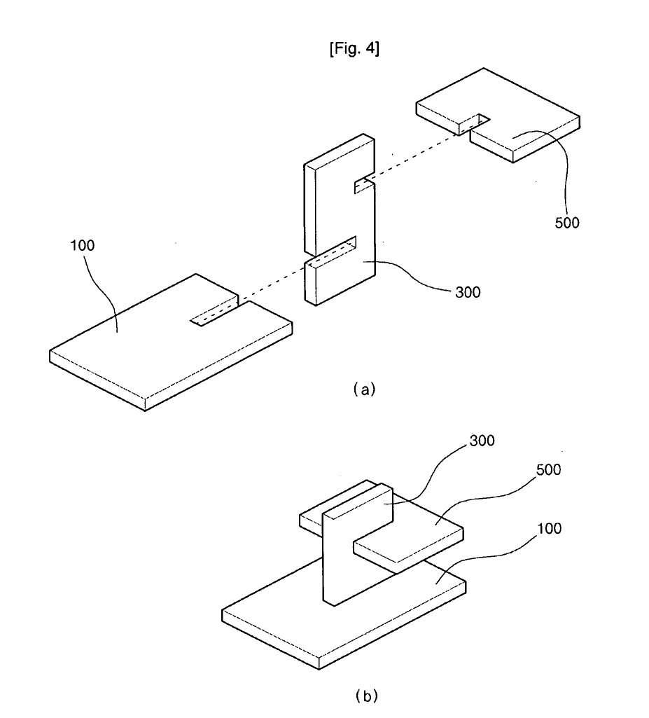

In order to implement a radiator having more various shapes, the dielectric element formed with the radiator may be implemented in plural numbers more than two. FIG. 4 is a perspective view illustrating the structure of three dielectric elements each having radiators formed thereon. In FIG. 4, radiators formed on the dielectric elements 100, 300 and 500 are not shown. FIG. 4(a) shows a state prior to the coupling between the first dielectric elements 100, 300 and 500, FIG. 4(b) shows a state after the coupling between the first dielectric element 100, 300 and 500.

While the invention has been described in connection with what is presently considered to be practical exemplary embodiments, it is to be understood that the invention is merely exemplary and not limited to the disclosed embodiments. Therefore, a person skilled in the art can perform various changes and modifications based on a principle of the present invention, which falls in the scope of the present invention. Therefore, the scope of the present invention should not be construed as being limited to the above described embodiment, but should be defined by the appended claims and the equivalents to the claims.

1. An antenna comprising:
a first dielectric element having a first slit formed thereon;
a first radiator formed on the first dielectric element;
a second dielectric element coupled to the first dielectric element in such a fashion as to be fit into the first slit of the first dielectric element; and
a second radiator formed on the second dielectric element and coupled electrically with the first radiator through the coupling between the first dielectric element and the second dielectric element.

2. The antenna according to claim 1, wherein the second dielectric element has a second slit formed thereon in such a fashion as to be opened at one end thereof, and
the first dielectric element is fit into the second slit of the second dielectric element upon the coupling between the first dielectric element and the second dielectric element.

3. The antenna according to claim 1 or 2, wherein the first slit is opened at one end thereof.

4. The antenna according to claim 1, wherein each of the first radiator and the second radiator is formed by printing a conductive ink on the first dielectric element and the second dielectric element, respectively.

5. A wireless terminal device comprising the antenna according to any one of claims 1 to 4.
